(19) United States
(12) Patent Application Publication
(10) Pub. No.: US 2025/0382728 A1
(43) Pub. Date: Dec. 18, 2025

(54) DOUBLE-LAYER FUNCTIONALIZED HOLLOW FIBER MEMBRANE AND PREPARATION METHOD THEREOF

(71) Applicant: Harbin Engineering University, Harbin (CN)

(72) Inventors: Jun Wang, Harbin (CN); Bingtao Zhang, Harbin (CN); Hongsen Zhang, Harbin (CN); Qi Liu, Harbin (CN); Jing Yu, Harbin (CN); Jiahui Zhu, Harbin (CN); Rongrong Chen, Harbin (CN); Jingyuan Liu, Harbin (CN); Rumin Li, Harbin (CN)

(73) Assignee: Harbin Engineering University, Harbin (CN)

(21) Appl. No.: 19/315,836

(22) Filed: Sep. 1, 2025

(30) Foreign Application Priority Data
Sep. 2, 2024 (CN) 202411217064.7

(51) Int. Cl. D01D 5/24; B01D 67/00; B01D 69/02; B01D 69/08; B01D 71/42; B01D 71/60; D01D 1/02; D01D 5/06; D01F 1/10; D01F 6/54; D01F 11/06

(52) U.S. Cl. CPC D01D 5/24; B01D 67/0011; B01D 67/0013; B01D 67/00165; B01D 69/02; B01D 69/08; B01D 71/421; B01D 71/601; D01D 1/02; D01D 5/06; D01F 1/103; D01F 6/54; D01F 11/06; B01D 2323/081; B01D 2323/10; B01D 2323/18; B01D 2323/60; B01D 2325/12; B01D 2325/48; D10B 2321/10; D10B 2331/30; D10B 2505/04

(57) ABSTRACT

The present disclosure relates to the research field of functionalized membrane materials and their preparation methods, in particular to a double-layer functionalized hollow fiber membrane and a preparation method thereof. The present disclosure provides a preparation method for a double-layer functionalized hollow fiber membrane, including preparation of the casting solutions, transverse extrusion casting solution, longitudinal stretching, the first coagulation bath, the second coagulation bath, and the third coagulation bath. The double-layer functionalized hollow fiber membrane prepared by the present disclosure has a double-functionalized layer structure with a dense cortical antibacterial layer and a macroporous structure adsorption layer. The double-layer functionalized hollow fiber membrane not only has the function of separation and purification, but also has the function of bacteriostasis and adsorption. The double-layer functionalized hollow fiber membrane has high strength, the wire is not easy to break, and it has a wide application field.

### TECHNICAL FIELD

The present disclosure relates to the research field of functionalized membrane materials and their preparation methods, in particular to a double-layer functionalized hollow fiber membrane and a preparation method thereof.

### BACKGROUND

The extraction of uranium from seawater and the treatment of nuclear wastewater require a large amount of adsorption and separation materials. The disclosure with an application number of 202311770819.1, prepares an amidoxime-modified polyacrylonitrile hollow fiber membrane for uranium extraction from seawater and its preparation method. An antibacterial layer is introduced into the outer layer so that the hollow fiber membrane has a bifunctionalized layer. The introduction of the antibacterial layer causes the following problems:

The antibacterial component is used as the first casting solution, and the antibacterial layer of the hollow fiber membrane is prepared separately. The adsorption active component is used as the second casting solution, and the adsorption layer of the hollow fiber membrane is prepared separately. The antibacterial layer is coated on the formed adsorption layer. The compatibility is poor, and the antibacterial layer can easily peel off from the adsorption layer. Even if the antibacterial layer does not peel off from the adsorption layer, because the adsorption layer has been formed, there is a dense layer on the surface of the adsorption layer, and when a antibacterial layer is coated on the adsorption layer, a dense layer is formed when the antibacterial layer is formed. Due to the existence of two dense layers, the flux of the prepared hollow fiber membrane is significantly reduced, which affects the performance of the hollow fiber membrane.

When the antibacterial components are not added on the hollow fiber membrane adsorption layer, bacteria can easily grow on the surface of the membrane, resulting in the adsorption sites on the surface of the adsorption material being wrapped by bacteria, which is not conducive to adsorption. While there is a problem of double-layer compatibility between the adsorption layer and the antibacterial layer when adding antibacterial components to the adsorption layer of hollow fiber membrane, adding and not adding an antibacterial layer on the adsorption layer of the hollow fiber membrane is a pair of contradictions. Therefore, the way of introducing an antibacterial layer into the adsorption material that can not only prevent the growth of bacteria on the surface of the adsorption material but also ensure that the adsorption layer and the antibacterial layer are well organically bonded into a whole is a technical problem.

The above problems influence and restrict each other, which seriously hinder the industrialization process of adsorption materials, and must be solved comprehensively and systematically. The existing technology to solve the above problems has the following technical difficulties:

The antibacterial component is used as the first casting solution, and the antibacterial layer of the hollow fiber membrane is prepared separately. The adsorption active component is used as the second casting solution, and the adsorption layer of the hollow fiber membrane is prepared separately. It is difficult to combine the antibacterial layer and the adsorption layer organically. First, whether the antibacterial layer is prepared for a period and then the adsorption layer is coated on the antibacterial layer, or the adsorption layer is prepared for a period and then the antibacterial layer is coated on the adsorption layer, there will be an initial layer on the prepared surface, giving the membrane material has two separate layers. The antibacterial layer and the adsorption layer are not firmly bonded, and the antibacterial layer and the adsorption layer are easily peeled off, so the functionalized hollow fiber membrane is not a whole, and the functionalized hollow fiber membrane can not be used; the second option is to prepare a layer and then immediately apply another layer on it. At this time, the first layer prepared is still in the liquid state. The second layer is easily infiltrated into the first layer under the action of gravity, which will cause the adsorption site to be embedded, so the adsorption of the adsorption active site in the adsorption component is inactivated. The antibacterial layer and the adsorption layer cannot play an independent role, and it is impossible to have a good organic combination of the antibacterial component layer and the adsorption active layer.

Since the adsorption layer has been formed, there is a dense layer on the surface of the adsorption layer, and then an antibacterial layer is coated on the adsorption layer. When the antibacterial layer is formed, a dense layer is formed. Due to the existence of a dense layer between the antibacterial layer and the adsorption layer, the flux of the prepared hollow fiber membrane is significantly reduced.

On the basis of the existing adsorption layer, the introduction of the antibacterial layer will increase the resistance of water through the hollow fiber membrane, which is not conducive to the passage of water through the hollow fiber membrane, resulting in a decrease in the flux of the hollow fiber membrane. The coating of the antibacterial component layer is too thick, and the prepared hollow fiber membrane can exhibit a good antibacterial effect, but the hollow fiber membrane has a low water flux due to the large water resistance. If the coating of the antibacterial component layer is too thin, there will be too few antibacterial components left in the membrane, and there will be no antibacterial effect.

The existing technology for preparing double-layer membranes generally uses a process in which two functionalized layer materials undergo phase transformation at the same time. This preparation process is generally difficult to achieve two functionalized materials with different shape and structures. The reasons are as follows: First, the adsorption layer is prepared first, and then another antibacterial layer is coated on it immediately. At this time, the prepared adsorption layer is still in the liquid state, and the antibacterial layer is easy to penetrate into the adsorption layer under the action of gravity. This will cause the antibacterial layer and the adsorption layer to be mixed together, unable to play a role independently, and can not obtain a double-layer functionalized hollow fiber membrane with a dense cortical antibacterial layer and a macroporous structure adsorption layer; secondly, the antibacterial layer and the adsorption layer are both immersed in water and undergo phase transformation at the same time. There is no control over the order of phase transformation, resulting in the formation of a dense skin layer in the adsorption layer. Therefore, it is impossible to prepare a double-layer functionalized hollow fiber membrane with both a dense skin antibacterial layer and a macroporous structure adsorption layer.

### SUMMARY

Given the above technical problems and their technical difficulties, the following technical ideas are proposed:

Because of the first technical difficulty: Firstly, the first casting solution and the second casting solution are prepared. The first casting solution is a uniform casting solution of polyacrylonitrile polymer material containing antibacterial components, and the second casting solution is a uniform casting solution of adsorption components grafted onto polyacrylonitrile polymer material. Secondly, the first casting solution and the second casting solution are sprayed from the spinneret transversely at the same time, and then the membrane forming process of longitudinal stretching is adopted, so that the mutual penetration between the two casting solutions can be avoided due to gravity. Finally, the inner lining is used to replace the core liquid, and the order of curing and forming of the casting membrane liquid is controlled to start from the antibacterial layer first, and the adsorption layer is finally formed. Meanwhile, the time when the casting membrane liquid leaks into the air is controlled. The casting membrane liquid directly enters the coagulation bath after coming out from the spinneret, so that the two layers will not be stratified. And the antibacterial layer is cured first, and the adsorption layer is cured later, so that the antibacterial component will not penetrate the adsorption layer. The synergy, complementarity and interaction among the processes constitute a whole, it fully guarantees the organic combination of the hollow fiber antibacterial layer and the adsorption layer, thereby preventing the phenomenons that the layers of the membrane materials are separated, the antibacterial layer and the adsorption layer are not firmly bonded, and the antibacterial layer and the adsorption layer are easily peeled off. It fully guarantees that the prepared functionalized hollow fiber membrane can be a whole.

Given the second technical difficulty: The present disclosure uses the first casting solution containing the antibacterial component and the second casting solution containing the adsorption component to extrude the feed liquid through the spinneret transversely, and controls the thickness of the mold between the two layers of the spinneret casting solution. Meanwhile, the inner lining is introduced, and the longitudinal stretching spinning is used to control the solidification and forming sequence of the casting solution. The first casting solution is solidified first, and the second casting solution is solidified later, so the dense skin layer between the two layers of the antibacterial layer and the adsorption layer can be eliminated, which can reduce the resistance of water through the double-layer functionalized hollow fiber membrane and increase the water flux.

Given the third technical difficulty: In this present disclosure, firstly, the antibacterial component and the adsorption active component are respectively prepared into the first casting solution and the second casting solution, which can ensure the uniformity and stability of the casting solution. Secondly, the two casting solutions are extruded transversely through the spinneret, and the inner lining is introduced and then longitudinally drawn. In order to control the solidification and molding sequence of the casting solution, the first casting solution is solidified first, so that the prepared double-layer functionalized hollow fiber membrane has a dense cortical structure. The antibacterial layer, and then the second casting solution, is solidified again, so that the prepared double-layer functionalized hollow fiber membrane has a macroporous structure adsorption layer, ensuring that the preparation can be guaranteed to have a double-layer functionalized hollow fiber membrane with a dense cortical antibacterial layer and a macroporous structure adsorption layer. The second is to increase the strength of the functionalized hollow fiber membrane. The third is to make the double-layer functionalized hollow fiber membrane easier to form; finally, through several different coagulation baths, coagulation bath composition and temperature control of double-layer functionalized hollow fiber membrane filament formation, the loss of antibacterial components and the diffusion of antibacterial components to the adsorption layer are prevented during the later membrane curing, the antibacterial layer and the adsorption layer can independently exert antibacterial and adsorption effects. Using the synergy, complement, and interaction between the processes to form a whole, it can fully ensure that the double-layer functionalized hollow fiber membrane has a double-layer structure of a dense cortical antibacterial layer and a macroporous adsorption layer.

Based on the above idea, the present disclosure makes full use of the synergy between the components and the process to form a whole, rather than a simple combination. The composition and proportion of the casting solution, the extrusion and stretching method of the casting solution, and the composition and temperature of the coagulation bath are systematically adjusted, and the membrane preparation process is coordinated to finally prepare a functionalized hollow fiber membrane.

In order to achieve the purpose of the present disclosure, the present disclosure adopts the following technical scheme:

A preparation method for a double-layer functionalized hollow fiber membrane, including the following steps:

Step 1: Preparation of casting solution: a formula of a first casting solution in mass percentage: 10%-16% polyacrylonitrile powder, 0.5%-5% water-insoluble antibacterial ingredient, 0.5%-10% thickener, 6%-15% porogen, 54%-83% solvent, a sum of each component is 100%. a preparation order of the first casting solution is as follows: First, adding a certain amount of solvent to a three necked flask, and adding porogen and thickener in turn according to a proportion of the formula of the first casting solution, heating and stirring, a heating temperature is 40° C.-80° C., a stirring time is 0.5 h, then adding polyacrylonitrile powder and water-insoluble antibacterial component according to the formula of the first casting solution, heating and stirring, the heating temperature is 60° C.-80° C., and the stirring time is 0.5 h, finally, adding a remaining solvent according to the formula of first casting solution, heating and stirring, the heating temperature is 60° C.-80° C., and then the stirring time is 8 h, and then adjusting a temperature of the first casting solution to 50° C., and defoaming by stirring at a speed of 10 r/min for 1 h-6 h under a negative pressure of 0.05 MPa, the first casting solution is obtained; the formula of a second casting solution in mass percentage is 8%-12% polyacrylonitrile powder, 1%-8% polyethyleneimine, 10%-15% pore-forming agent, 65%-81% solvent, and the sum of each component is 100%; the preparation order of second casting solution is as follows: first, adding a certain amount of solvent to a three-necked flask, and adding the pore-forming agent according to the formula of the second casting solution, heating and stirring, and the heating temperature is 50° C.-80° C., and then adding the polyacrylonitrile powder according to the formula of second casting solution, heating and stirring, the heating temperature is 50° C.-80° C., and the stirring time is 0.5 h, and then adding polyethyleneimine according to the formula of second casting solution, finally, adding the remaining solvent according to the formula of the second casting solution, heating and stirring, the heating temperature is 60° C.-80° C., and then the stirring time is 8 h, and then adjusting the temperature of the second casting solution to 50° C., under the negative pressure of 0.05 MPa, standing for 1 h-6 h, the second casting solution is obtained.

Step 2: Putting an inner lining into a spinneret through a wire feeding device, and the inner lining replaces a core liquid, and putting the first casting solution and the second casting solution a feeding pump at 0.3 MPa, the feeding pump injecting different amounts of the first casting solution and the second casting solution into the spinneret transversely at the same time by adjusting the speed, coating the second casting solution on the inner lining, and coating the first casting solution on the outer side of the second casting solution, stretching the inner lining longitudinally and directly entering a first coagulation bath.

Step 3: The first coagulation bath is composed of a mixture of 95%-99.5% pure water and 0.5%-5% water-soluble antibacterial component, controlling a temperature of the mixture in the first coagulation bath at 41° C.-50° C., the residence time of the functionalized hollow fiber membrane in the first coagulation bath is 10 s-30 s, putting the functionalized hollow fiber membrane into the second coagulation bath after coming out of the first coagulation bath.

Step 4: The second coagulation bath consists of a mixture of 50%-90% pure water and 10%-50% chelating agent, controlling the pure water temperature in the second coagulation bath at 41° C.-50° C., and putting the functionalized hollow fiber membrane in the third coagulation bath after coming out of the second coagulation bath.

Step 5: The third coagulation bath is composed of pure water, and controlling the temperature of the third coagulation bath at 50° C.-80° C. to obtain a functionalized hollow fiber membrane.

Where the water-insoluble antibacterial component is one or two of cuprous oxide and copper oxide, the water-soluble antibacterial component is one or two of copper chloride and copper sulfate, and the thickener is one or more of PVPK90, PVPK60, PVPK30, POLYOX WSR N-750, POLYOX WSR N-80, POLYOX WSR N-10, POLYOX WSR N-308, methyl cellulose, carboxymethyl cellulose, hydroxyethyl cellulose, and hydroxypropyl methyl cellulose, the chelating agent is one or two of ethylenediaminetetraacetic acid disodium and ethylenediaminetetraacetic acid tetrasodium.

Technical description: Step 1: Preparation the first casting solution and the second casting solution separately is to ensure the uniformity and stability of the casting solution; adding water-insoluble antibacterial components to first casting solution: On the one hand, it is used to make the prepared functionalized membrane have antibacterial function, on the other hand, it is used to make the antibacterial components not lose to the first coagulation bath when first casting solution enters the first coagulation bath, so that the prepared functionalized hollow fiber membrane has more antibacterial components. The thickening agent is added to the first casting solution to increase the viscosity of the first casting solution, thereby preventing the aggregation or stratification of the water-insoluble antibacterial components in the prepared first casting solution. The first casting solution is stirred and defoamed at a speed of 10 r/min for 1 h-6 h to prevent the aggregation of water-insoluble antibacterial components or stratification due to gravity; polyethyleneimine is added to second casting solution: On the one hand, it is used to make the prepared functionalized hollow fiber membrane have adsorption function, on the other hand, it is used to graft polyethyleneimine onto polyacrylonitrile during the preparation of second casting solution, so that polyethyleneimine can be stably present in the functionalized hollow fiber membrane.

Step 2: The inner lining replaces the core liquid in Step 2: 1. To control the solidification and molding sequence of the casting solution, the first casting solution is solidified first, and the second casting solution is solidified later, which can prevent the antibacterial component from spreading to the adsorption layer during the initial ecological membrane. 2. It is used to increase the strength of the functionalized hollow fiber membrane, 3. It is used to ensure that the prepared functionalized hollow fiber membrane has a dense cortical antibacterial layer and a macroporous structure adsorption layer. 4. It is used to make the functionalized hollow fiber membrane easy to form. Different amounts of first casting solution and second casting solution are injected into the spinneret at the same time by adjusting the rotational speed of the feed pump: on the one hand, it is used to control the thickness of the antibacterial layer and the adsorption layer respectively; on the other hand, it is used to make the antibacterial layer and the adsorption layer bond well, thereby preventing the phenomenons that the layers of the membrane materials are separated, the antibacterial layer and the adsorption layer are not firmly bonded, and the antibacterial layer and the adsorption layer are easily peeled off. It fully guarantees that the prepared functionalized hollow fiber membrane can be a whole; the liner is stretched longitudinally directly into the first coagulation bath to avoid penetration between the two casting solutions due to gravity.

Step 3: The composition of the first coagulation bath in Step 3 is a mixture of 95%-99.5% pure water and 0.5%-5% water-soluble antibacterial component, which is to fully ensure that when the casting solution enters the first coagulation bath and the instantaneous phase is transformed into the initial state membrane, on the one hand, the antibacterial components will not diffuse into the first coagulation bath, on the other hand, the functionalized hollow fiber membrane will form a dense layer on the outer surface of the antibacterial layer to prevent the loss of antibacterial component in the later stage; the temperature of the mixture in the first coagulation bath is controlled at 41° C.-50° C. to regulate the instantaneous phase transformation rate and prevent the diffusion of antibacterial components into the first coagulation bath. The residence time of the functionalized hollow fiber membrane in the first coagulation bath is controlled to be 10 s-30 s in order to prevent the water-soluble antibacterial component in the first coagulation bath from entering the adsorption layer.

Step 4: The second coagulation bath in Step 4 consists of a mixture of 50%-90% pure water and 10%-50% chelating agent. On the one hand, it is used to remove the residual water-soluble antibacterial component in the first coagulation bath on the functionalized hollow fiber membrane. On the other hand, it is used to migrate the water-insoluble antibacterial components in the first casting solution to the outer surface to prevent the water-insoluble antibacterial components from diffusing to the adsorption layer; the temperature of pure water in the second coagulation bath is controlled at 41° C.-50° C., which is to control the phase transformation rates of first casting solution and second casting solution, and to ensure that the prepared functionalized hollow fiber membrane has a dense skin layer and a macroporous structure adsorption layer. Meanwhile, it prevents the phenomenons that the layers of the membrane materials are separated, the antibacterial layer and the adsorption layer are not firmly bonded, and the antibacterial layer and the adsorption layer are easily peeled off. It fully guarantees that the prepared functionalized hollow fiber membrane can be a whole.

Step 5: The third coagulation bath in Step 5 is composed of pure water, in order to fully elute the solvent in the casting solution; the third coagulation bath temperature is controlled at 50° C.-80° C. On the one hand, the antibacterial layer and the adsorption layer are more firmly bonded, the antibacterial layer and the adsorption layer are more difficult to peel off. On the other hand, the adsorption layer and the lining are more closely bonded, so that the antibacterial layer, the adsorption layer, and the lining are more closely bonded, fully ensuring that the prepared functionalized hollow fiber membrane is a whole.

Beneficial effects: (1) The prepared double-layer functionalized hollow fiber membrane has a three-layer structure with the outermost layer as the antibacterial layer, the middle layer as the adsorption layer, and the innermost layer as the support layer. The three-layer structure is an organic whole; (2) The structure of the functionalized hollow fiber membrane can be regulated, so that the double-layer functionalized hollow fiber membrane has a dense skin layer with antibacterial function and a macroporous structure with adsorption function; (3) The double-layer functionalized hollow fiber membrane not only has the function of separation and purification, but also has the function of bacteriostasis and adsorption. (4) The double-layer functionalized hollow fiber membrane has high strength, is not easy to break, and has a wide application field.

### BRIEF DESCRIPTION OF THE DRAWINGS

FIG. 1: Microscopic images of the double-layer functionalized hollow fiber membranes prepared by Example 1, the antibacterial layers of membranes are in different thicknesses.

FIG. 2: Cross-sectional scanning electron microscope image of the double-layer functionalized hollow fiber membrane prepared by Example 2.

FIG. 3: Infrared image of the double-layer functionalized hollow fiber membrane prepared by Example 3.

FIG. 4: XPS spectra of Cu2p in the double-layer functionalized hollow fiber membrane prepared by Example 4.

FIG. 5: Cross-sectional scanning electron microscope image of the double-layer functionalized hollow fiber membrane prepared by Example 8.

FIG. 6: Antibacterial images of the double-layer functionalized hollow fiber membrane prepared by Example 10.

### DETAILED DESCRIPTION OF THE EMBODIMENTS

The following is a detailed description of the present disclosure in combination with specific examples. The following examples will help technicians in the field to further understand the present disclosure, but do not restrict the present disclosure in any way. It should be pointed out that for the ordinary technical personnel in this field, some deformations and improvements can be made without breaking away from the idea of the present disclosure. These are all within the scope of protection of the present disclosure.

### Example 1

A preparation method for the double-layer functionalized hollow fiber membrane, including the following steps:

Step 1: Preparation of casting solution: the formula of a first casting solution in mass percentage: 10%-16% polyacrylonitrile powder, 0.5%-5% water-insoluble antibacterial ingredient, 0.5%-10% thickener, 6%-15% porogen, 54%-83% solvent, the sum of each component is 100%. The preparation order of the first casting solution is as follows: First, a certain amount of solvent is added to a three necked flask, and porogen and thickener are added in turn according to the proportion of the first casting solution formula. Heating and stirring, the heating temperature is 40° C.-80° C., the stirring time is 0.5 h. Then, polyacrylonitrile powder and water-insoluble antibacterial components are added according to the formula of the first casting solution, heating and stirring, the heating temperature is 60° C.-80° C., and the stirring time is 0.5 h. Finally, the remaining solvent is added according to the formula of the first casting solution, heating and stirring, the heating temperature is 60° C.-80° C., and then the stirring time is 8 h. Then the temperature of the first casting solution is adjusted to 50° C., and defoamed by stirring at a speed of 10 r/min for 1 h-6 h under a negative pressure of 0.05 MPa to obtain the first casting solution. The formula of the second casting solution in mass percentage is 8%-12% polyacrylonitrile powder, 1%-8% polyethyleneimine, 10%-15% pore-forming agent, 65%-81% solvent, and the sum of each component is 100%. The preparation order of the second casting solution is as follows: First, a certain amount of solvent is added to the three-necked flask, and the pore-forming agent is added according to the formula of the second casting solution, heated and stirred, and the heating temperature is 50° C.-80° C. Then the polyacrylonitrile powder is added according to the formula of the second casting solution, heated and stirred, the heating temperature is 50° C.-80° C., and the stirring time is 0.5 h. Then, polyethyleneimine is added according to the formula of the second casting solution. Finally, the remaining solvent is added according to the formula of the second casting solution, heating and stirring, the heating temperature is 60° C.-80° C., and then the stirring time is 8 h, and then the temperature of the second casting solution is adjusted to 50° C. Under the negative pressure of 0.05 MPa, standing for 1 h-6 h, the second casting solution is obtained.

Step 2: The inner lining enters the spinneret through the wire feeding device, and the inner lining replaces the core liquid. The first casting solution and the second casting solution enter the feeding pump at 0.3 MPa. The feeding pump injects different amounts of the first casting solution and the second casting solution into the spinneret transversely at the same time by adjusting the speed. The second casting solution is coated on the inner lining, and the first casting solution is coated on the outer side of the second casting solution. The inner lining is longitudinally stretched and directly enters the first coagulation bath.

Step 3: The first coagulation bath was composed of a mixture of 95%-99.5% pure water and 0.5%-5% water-soluble antibacterial component. The temperature of the mixture in the first coagulation bath is controlled at 41° C.-50° C. The residence time of the functionalized hollow fiber membrane in the first coagulation bath is 10 s-30 s. The functionalized hollow fiber membrane enters the second coagulation bath after coming out of the first coagulation bath.

Step 4: The second coagulation bath consists of a mixture of 50%-90% pure water and 10%-50% chelating agent. The pure water temperature in the second coagulation bath is controlled at 41° C.-50° C., and the functionalized hollow fiber membrane enters the third coagulation bath after coming out of the second coagulation bath.

Step 5: The third coagulation bath is composed of pure water, and the third coagulation bath temperature is controlled at 50° C.-80° C. to obtain a functionalized hollow fiber membrane.

Where the water-insoluble antibacterial component is one or two of cuprous oxide and copper oxide, the water-soluble antibacterial component is one or two of copper chloride and copper sulfate, and the thickener is one or more of PVPK90, PVPK60, PVPK30, POLYOX WSR N-750, POLYOX WSR N-80, POLYOX WSR N-10, POLYOX WSR N-308, methyl cellulose, carboxymethyl cellulose, hydroxyethyl cellulose, and hydroxypropyl methyl cellulose. The chelating agent is one or two of ethylenediaminetetraacetic acid disodium and ethylenediaminetetraacetic acid tetrasodium.

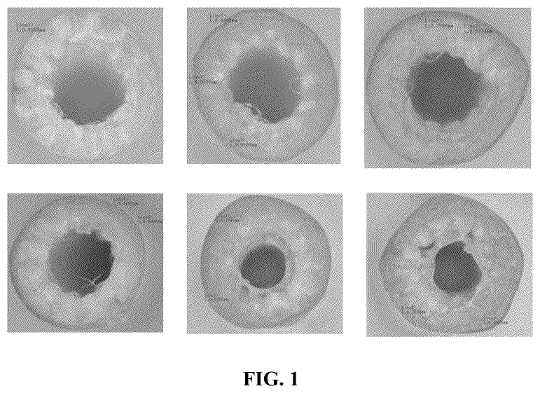

The functionalized hollow fiber membranes with different antibacterial layer thicknesses were prepared in this example. Microscopic images of the double-layer functionalized hollow fiber membranes are shown in FIG. 1, in which the antibacterial layers of membranes are in different thicknesses.

### Example 2

The preparation method for a double-layer functionalized hollow fiber membrane described in this example is basically the same as that described in Example 1. The difference is that the water-insoluble antibacterial component of the first casting solution in Step 1 is cuprous oxide, with a proportion of 1%. In Step 3, the first coagulation bath is composed of a mixture of 99% pure water and 1% water-soluble antibacterial component copper chloride. The mixture in the first coagulation bath is controlled at 45° C., and the residence time of the functionalized hollow fiber membrane in the first coagulation bath is 10 s.

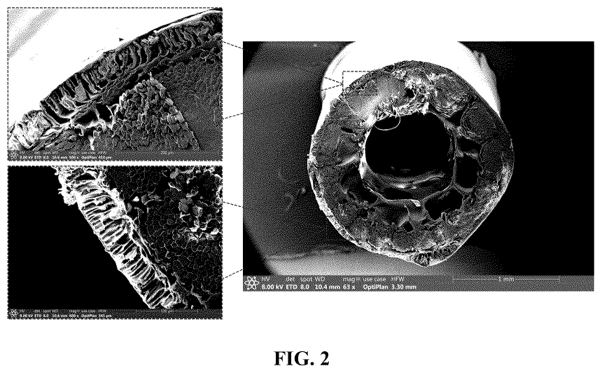

Technical description: This example regulates the composition and proportion of water-insoluble antibacterial component, the composition and temperature of the first coagulation bath, and the residence time of the functionalized hollow fiber membrane in the first coagulation bath, in order to prevent the water-insoluble antibacterial component, cuprous oxide, from diffusing to the first coagulation bath. At the same time, it prevents the water-soluble antibacterial components in the first coagulation bath from entering the adsorption layer, and fully ensures that the prepared functionalized hollow fiber membrane has antibacterial function. The cross-sectional scanning electron microscope image of the double-layer functionalized hollow fiber membrane prepared by Example 2 is shown in FIG. 2.

### Example 3

The preparation method for a double-layer functionalized hollow fiber membrane described in this example is basically the same as that described in Example 2. The difference is that the second coagulation bath in Step 4 consists of a mixture of 50% pure water and 50% chelating agent ethylenediamine tetraacetic acid disodium salt.

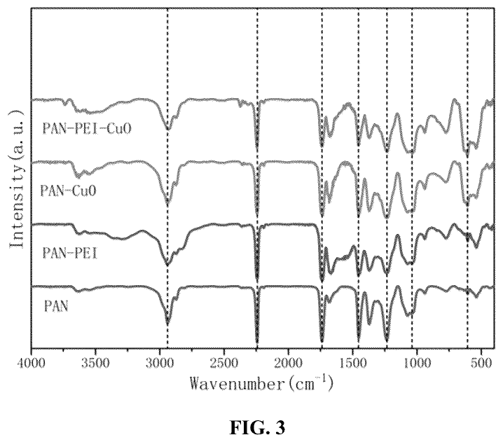

Technical description: The composition of the second coagulation bath is regulated in this example. On the one hand, it is used to remove the residue of water-soluble antibacterial components on the functionalized hollow fiber membrane in the first coagulation bath, and on the other hand, it is used to migrate the water-insoluble antibacterial component in the first casting solution migrate to the outer surface and prevent the water-insoluble antibacterial components from spreading to the adsorption layer. The infrared image of the double-layer functionalized hollow fiber membrane prepared by Example 3 is shown in FIG. 3.

### Example 4

The preparation method for a double-layer functionalized hollow fiber membrane described in this example is basically the same as that described in Example 3. The difference is that the pure water temperature in the second coagulation bath in Step 4 is controlled at 50° C.; in Step 5, the temperature of the third coagulation bath is controlled at 80° C.

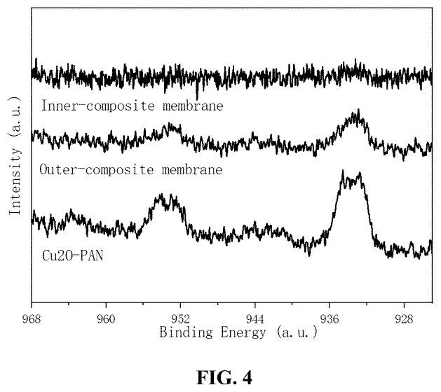

Technical description: The temperature of the second coagulation bath is controlled in this example to control the phase transformation rates of the first casting solution and the second casting solution, and to ensure that the prepared functionalized hollow fiber membrane has a dense skin layer and a macroporous structure adsorption layer. At the same time, it prevents the phenomenons that the layers of the membrane materials are separated, the antibacterial layer and the adsorption layer are not firmly bonded, and the antibacterial layer and the adsorption layer are easily peeled off. It fully guarantees that the prepared functionalized hollow fiber membrane can be a whole. Regulating the temperature of the third coagulation bath, on the one hand, it is used to bond the antibacterial layer and the adsorption layer more firmly, and the antibacterial layer and the adsorption layer are more difficult to peel off, on the other hand, it is used to bond the adsorption layer and the lining more closely, so that the antibacterial layer, the adsorption layer and the lining are more closely bonded, fully ensuring that the prepared functionalized hollow fiber membrane is a whole. The XPS spectrum of the double-layer functionalized hollow fiber membrane prepared by Example 4 is shown in FIG. 4.

### Example 5

The preparation method for a double-layer functionalized hollow fiber membrane described in this example is basically the same as that described in Example 1. The difference is that in Step 1, the first casting solution contains a water-insoluble antibacterial component, copper oxide, the proportion is 0.5%, the thickener is POLYOX WSR N-750, the proportion is 2%, and the second casting solution contains polyethyleneimine 4%.

Technical description: This example regulates the composition and proportion of the first casting solution and the second casting solution to ensure the uniformity and stability of the first casting solution and the second casting solution.

### Example 6

The preparation method for a double-layer functionalized hollow fiber membrane described in this example is basically the same as that described in Example 5. The difference is that the first coagulation bath in Step 3 consists of a mixture of 99.5% pure water and 0.5% water-soluble antibacterial component copper sulfate.

Technical description: This example regulates the composition of the first coagulation bath in order to prevent the diffusion of the water-insoluble antibacterial component copper oxide into the first coagulation bath, and fully ensures that the prepared functionalized hollow fiber membrane has antibacterial function.

### Example 7

The preparation method for a double-layer functionalized hollow fiber membrane described in this example is basically the same as that described in Example 6. The difference is that the second coagulation bath in Step 4 consists of a mixture of 60% pure water and 40% chelating agent ethylenediamine tetraacetic acid tetrasodium salt.

Technical description: The example regulates the composition of the second coagulation bath, on the one hand, it is used to remove the residual water-soluble antibacterial components in the first coagulation bath on the functionalized hollow fiber membrane, and on the other hand, it is used to migrate the water-insoluble antibacterial components in the first casting solution to the outer surface to prevent the water-insoluble antibacterial components from diffusing to the adsorption layer.

### Example 8

The preparation method for a double-layer functionalized hollow fiber membrane described in this example is basically the same as that described in Example 7. The difference is that the mixture temperature in the first coagulation bath of Step 3 is controlled at 50° C., and the residence time of the functionalized hollow fiber membrane in the first coagulation bath is 30 s.

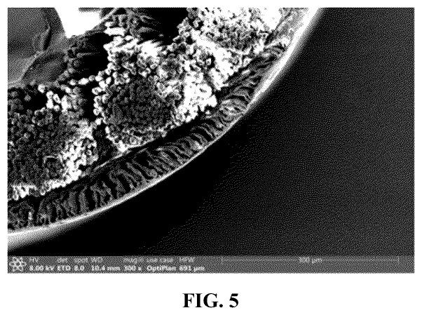

Technical description: In this example, the temperature of the first coagulation bath and the residence time of the functionalized hollow fiber membrane in the first coagulation bath are controlled to regulate the rate of instantaneous phase transformation of first casting solution, the diffusion of water-insoluble antibacterial component copper oxide to the first coagulation bath is prevented, and the water-soluble antibacterial component in the first coagulation bath is kept from entering the adsorption layer, to fully ensure that the prepared functionalized hollow fiber membrane has antibacterial function. The cross-sectional scanning electron microscope image of the double-layer functionalized hollow fiber membrane prepared by example 8 is shown in FIG. 5.

### Example 9

The preparation method for a double-layer functionalized hollow fiber membrane described in this example is basically the same as that described in Example 8. The difference is that the pure water temperature in the second coagulation bath in Step 4 is controlled at 50° C.; in Step 5, the temperature of the third coagulation bath is controlled at 50° C.

Technical description: The temperature of the second coagulation bath is controlled in this example to control the phase transformation rates of the first casting solution and the second casting solution, and to ensure that the prepared functionalized hollow fiber membrane has a dense layer and a macroporous structure adsorption layer. At the same time, it prevents the phenomenons that the layers of the membrane materials are separated, the antibacterial layer and the adsorption layer are not firmly bonded, and the antibacterial layer and the adsorption layer are easily peeled off. It fully guarantees that the prepared functionalized hollow fiber membrane can be a whole. Adjusting the temperature of the third coagulation bath, on the one hand, it is used to bond the antibacterial layer and the adsorption layer more firmly, and the antibacterial layer and the adsorption layer are more difficult to peel off. On the other hand, it is used to bond the adsorption layer and the lining more closely, so that the antibacterial layer, the adsorption layer, and the lining are more closely bonded, fully ensuring that the prepared functionalized hollow fiber membrane is a whole.

### Example 10

The preparation method for a double-layer functionalized hollow fiber membrane described in this example and Example 1 is basically the same. The difference is that the water-insoluble antibacterial component of the first casting solution in Step 1 is cuprous oxide, the proportion is 5%, and the thickener is PVPK30, the proportion is 10%; in Step 3, the first coagulation bath consists of a mixture of 95% pure water and 5% water-soluble antibacterial component copper sulfate. The temperature of the mixture in the first coagulation bath is controlled at 41° C., and the residence time of the functionalized hollow fiber membrane in the first coagulation bath is 20 s. In Step 4, the composition of the second coagulation bath is a mixture of 90% pure water and 10% chelating agent ethylenediaminetetraacetic acid disodium and ethylenediaminetetraacetic acid tetrasodium. The pure water temperature in the second coagulation bath is controlled at 41° C. In Step 5, the temperature of the third coagulation bath is controlled at 65° C.

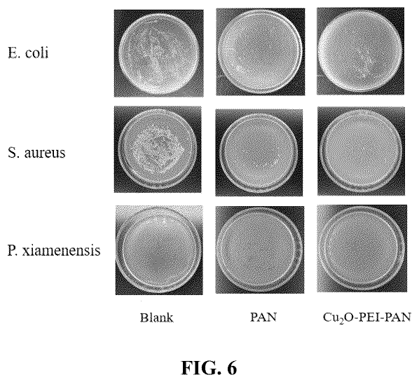

Technical description: This example regulates the composition and proportion of the first casting solution to prepare a uniform and stable casting solution; the regulation of the composition and temperature of the first coagulation bath is to regulate the rate of instantaneous phase transformation of first casting solution, the diffusion of water-insoluble antibacterial component copper oxide to the first coagulation bath is prevented, and so that the prepared functionalized hollow fiber membrane has antibacterial function. The residence time of the functionalized hollow fiber membrane in the first coagulation bath is controlled to prevent the water-soluble antibacterial components in the first coagulation bath from entering the adsorption layer. The control of the composition and temperature of the second coagulation bath is to control the phase transformation rates of the first casting solution and second casting solution, so that the prepared functionalized hollow fiber membrane has a dense cortical antibacterial layer and a macroporous adsorption layer, and it prevents the phenomenons that the layers of the membrane materials are separated, the antibacterial layer and the adsorption layer are not firmly bonded, and the antibacterial layer and the adsorption layer are easily peeled off. It fully guarantees that the prepared functionalized hollow fiber membrane can be a whole; adjusting the temperature of the third coagulation bath, on the one hand, it is used to bond the antibacterial layer and the adsorption layer more firmly, and the antibacterial layer and the adsorption layer are more difficult to peel off. On the other hand, it is used to bond the adsorption layer and the lining more closely, so that the antibacterial layer, the adsorption layer, and the lining are more closely bonded, fully ensuring that the prepared functionalized hollow fiber membrane is a whole. The antibacterial images of the double-layer functionalized hollow fiber membrane prepared by Example 10 are shown in FIG. 6.

What is claimed is:

1. A preparation method for a double-layer functionalized hollow fiber membrane, comprising the following steps:
step 1: preparation of a first casting solution and a second casting solution, wherein a formula of the first casting solution in mass percentage is:
10%-16% polyacrylonitrile powder, 0.5%-5% water-insoluble antibacterial ingredient, 0.5%-10% thickener, 6%-15% porogen, 54%-83% solvent, and the sum of each component is 100%;
wherein a preparation order of the first casting solution is as follows:
first, adding a certain amount of solvent to a three necked flask,
adding porogen and thickener in turn according to a proportion of the formula of the first casting solution,
heating and stirring, wherein a heating temperature is 40° C.-80° C., and a stirring time is 0.5 h,
adding polyacrylonitrile powder and water-insoluble antibacterial component according to the formula of the first casting solution,
heating and stirring, wherein the heating temperature is 60° C.-80° C., and the stirring time is 0.5 h,
adding a remaining solvent according to the formula of first casting solution, heating and stirring, wherein the heating temperature is 60° C.-80° C., and the stirring time is 8 h,
adjusting a temperature of the first casting solution to 50° C.,
defoaming by stirring at a speed of 10 r/min for 1 h-6 h under a negative pressure of 0.05 MPa, thus obtaining the first casting solution;
wherein the formula of the second casting solution in mass percentage is:
8%-12% polyacrylonitrile powder, 1%-8% polyethyleneimine, 10%-15% pore-forming agent, 65%-81% solvent, and the sum of each component is 100%;
wherein a preparation order of second casting solution is as follows:
first, adding a certain amount of solvent to a three-necked flask,
adding the pore-forming agent according to the formula of the second casting solution,
heating and stirring, wherein the heating temperature is 50° C.-80° C.,
adding the polyacrylonitrile powder according to the formula of second casting solution,
heating and stirring, wherein the heating temperature is 50° C.-80° C., and the stirring time is 0.5 h,
adding polyethyleneimine according to the formula of the second casting solution,
adding the remaining solvent according to the formula of the second casting solution,
heating and stirring, wherein the heating temperature is 60° C.-80° C., and the stirring time is 8 h,
adjusting the temperature of the second casting solution to 50° C., under the negative pressure of 0.05 MPa, and allowing to stand for 1 h-6 h, thus obtaining the second casting solution;
step 2: putting an inner lining into a spinneret through a wire feeding device, wherein the inner lining replaces a core liquid, and putting the first casting solution and the second casting solution into a feeding pump at 0.3 MPa,
wherein the feeding pump injects different amounts of the first casting solution and the second casting solution into the spinneret transversely at the same time by adjusting the speed, coating the second casting solution on the inner lining, and coating the first casting solution on an outer side of the second casting solution, and stretching the inner lining longitudinally; directly entering a first coagulation bath;
step 3: controlling a temperature of the mixture in the first coagulation bath at 41° C.-50° C., wherein the first coagulation bath is composed of a mixture of 95%-99.5% pure water and 0.5%-5% water-soluble antibacterial component,
wherein the residence time of the functionalized hollow fiber membrane in the first coagulation bath is 10 s-30 s, and,
putting the functionalized hollow fiber membrane into a second coagulation bath after coming out of the first coagulation bath;
step 4: controlling the pure water temperature in the second coagulation bath at 41° C.-50° C., wherein the second coagulation bath consists of a mixture of 50%-90% pure water and 10%-50% chelating agent,
putting the functionalized hollow fiber membrane in the third coagulation bath after coming out of the second coagulation bath;
step 5: controlling the temperature of the third coagulation bath at 50° C.-80° C., wherein the third coagulation bath is composed of pure water,
thus obtaining a functionalized hollow fiber membrane;
wherein the water-insoluble antibacterial component is one or two of cuprous oxide and copper oxide,
the water-soluble antibacterial component is one or two of copper chloride and copper sulfate,
the thickener is one or more of PVPK90, PVPK60, PVPK30, POLYOX WSR N-750, POLYOX WSR N-80, POLYOX WSR N-10, POLYOX WSR N-308, methyl cellulose, carboxymethyl cellulose, hydroxyethyl cellulose, and hydroxypropyl methyl cellulose;
and the chelating agent is one or both of ethylenediaminetetraacetic acid disodium and ethylenediaminetetraacetic acid tetrasodium.

2. The preparation method for the double-layer functionalized hollow fiber membrane according to claim 1, wherein in step 1, the water-insoluble antibacterial component of the first casting solution 1 is cuprous oxide, with a ratio of 1%; in step 3
wherein the first coagulation bath consists of a mixture of 99% pure water and 1% water-soluble antibacterial component copper chloride,
wherein the first coagulation bath is controlled at 45° C., and
wherein a residence time of the functionalized hollow fiber membrane in the first coagulation bath is 10 s.

3. The preparation method for the double-layer functionalized hollow fiber membrane according to claim 2, wherein in step 4, the second coagulation bath consists of a mixture of 50% pure water and 50% chelating agent disodium ethylenediaminetetraacetate.

4. The preparation method for the double-layer functionalized hollow fiber membrane according to claim 3, wherein in step 4, the temperature of pure water in the second coagulation bath is controlled at 50° C.; and
wherein, in step 5, the temperature of the third coagulation bath is controlled at 80° C.

5. The preparation method for the double-layer functionalized hollow fiber membrane according to claim 1, wherein in step 1, the water-insoluble antibacterial component of the first casting solution is copper oxide, with a ratio of 0.5%, and the thickener is POLYOX WSR-N-750, with a ratio of 2%, the second casting solution is polyethyleneimine, with a ratio of 4%.

6. The preparation method for the double-layer functionalized hollow fiber membrane according to claim 5, wherein in step 3, the first coagulation bath consists of a mixture of 99.5% pure water and 0.5% water-soluble antibacterial component copper sulfate.

7. The preparation method for the double-layer functionalized hollow fiber membrane according to claim 6, wherein in step 4, the second coagulation bath is a mixture of 60% pure water and 40% chelating agent ethylenediaminetetraacetic acid tetrasodium salt.

8. The preparation method for the double-layer functionalized hollow fiber membrane according to claim 7, wherein in step 3, the temperature of the mixture in the first coagulation bath is controlled at 50° C., and the residence time of the functionalized hollow fiber membrane in the first coagulation bath is 30 s.

9. The preparation method for the double-layer functionalized hollow fiber membrane according to claim 8, wherein in step 4, the temperature of pure water in the second coagulation bath is controlled at 50° C.; in step 5, the third coagulation bath temperature is controlled at 50° C.

10. The preparation method for the double-layer functionalized hollow fiber membrane according to claim 1, wherein in step 1, the water-insoluble antibacterial component of the first casting solution is cuprous oxide, with a ratio of 5%, and the thickener is PVPK30, with a ratio of 10%;
wherein the first coagulation bath in step 3 consists of a mixture of 95% pure water and 5% water-soluble antibacterial component copper sulfate,
wherein the temperature of the mixture in the first coagulation bath is controlled at 41° C.,
wherein the residence time of the functionalized hollow fiber membrane in the first coagulation bath is 20 s;
wherein, in step 4, the composition of the second coagulation bath is a mixture of 90% pure water and 10% chelating agent ethylenediaminetetraacetic acid disodium and ethylenediaminetetraacetic acid tetrasodium and the pure water temperature in the second coagulation bath is controlled at 41° C.; and,
wherein, in step 5, the third coagulation bath temperature is controlled at 65° C.
